(19) United States
(12) Patent Application Publication
(10) Pub. No.: US 2004/0064420 A1
(43) Pub. Date: Apr. 1, 2004

(54) System and method for message communication

(76) Inventor: Walter D. Buist, Hasbrouck Heights, NJ (US)

Correspondence Address: JONES DAY, 222 EAST 41ST STREET, NEW YORK, NY, 10017, US

(21) Appl. No.: 10/666,817

(22) Filed: Sep. 17, 2003

Related U.S. Application Data
(60) Provisional application No. 60/411,200, filed on Sep. 17, 2002.

(51) Int. Cl. G06F 17/60

(52) U.S. Cl. 705/64

(57) ABSTRACT

A preferred embodiment of the present invention enables a sender of a financial message adhering to a field delimited communication protocol to use an entry in a specified field of the protocol to communicate a coded message having a meaning outside the publicly-known meaning within the protocol. In an exemplary embodiment, a sender of a Financial Information Exchange (FIX) message uses the order quantity field (“tag 38”) to communicate coded instructions to the message receiver on how to interpret the contents of the order message.

A preferred embodiment allows a party to define how values placed in the specified field will be interpreted. The exact meaning given to the coded number(s) may be different for each sender/receiver pair, or the same or similar codes may be used between a single sender and a plurality of receivers, as well as between any number of sender/receiver pairs.

### CROSS-REFERENCE TO RELATED APPLICATIONS

This application claims priority to U.S. provisional patent application No. 60/411,200, filed Sep. 17, 2002 entitled “SYSTEM AND METHOD FOR MESSAGE COMMUNICATION.” The entire contents of that application are incorporated herein by reference.

### BACKGROUND OF THE INVENTION

The Financial Information Exchange (FIX) Protocol, originated in 1992 by members of the financial community (the FIX committee), is an open standard specification for automating the trading of financial instruments. The FIX committee publishes the protocol and related information on the Web site “www.fixprotocol.org.”

The protocol was created for the purpose of streamlining a pre-existing manual process, largely dependent on the telephone and fax machine. It replaced these inefficient and diverse mechanisms with a uniform direct computer-to-computer communication mechanism.

The protocol describes a standard set of electronic messages that can be exchanged for communicating interests in buying and selling, orders to buy and sell, and reports of purchases and sales.

The specification is generally referred to as a type “tag equals value”, because each specific item (sometimes called a field) of financial data (order price, order quantity, etc.) is assigned a unique number called a tag, and arranged in a message sent by a sender to a receiver with the tag followed by the equal sign character (“=”) followed by the item (field) value.

For example, tag number 38 is assigned by the FIX protocol to the number of shares ordered. A sender wishing to order 5000 shares of stock arranges the quantity ordered field in a message with the tag number (“38”) followed by an equal sign (“=”) followed by the actual number of shares ordered (“5000”), for a quantity ordered field entry of “38=5000”.

However, in systems utilizing, or derived from, the FIX protocol, the message sender and message receiver are constrained by the specifications of the protocol, i.e., buyers or sellers cannot interpret messages other than within the FIX specification. Specifically, where a buyer indicates 38=5000, the quantity value “5000” associated with tag number “38” indicates the number of shares of stock a buyer wishes to purchase, and nothing more. The complement is true for sellers wanting to sell a particular number of shares. Additionally, in “active” systems, where the sender's request is distributed to a plurality of receivers, the exact request is known to all the receivers, even where the sender may desire to keep this information confidential. Furthermore, systems that expand on the FIX protocol are typically costly, require additional software or hardware, and in turn, require additional training and/or education of the users.

### SUMMARY OF THE INVENTION

The present invention enables a sender of a financial message adhering to a field delimited communication protocol to use an entry in a specified field of the protocol to communicate a coded message having a meaning outside the publicly-known meaning within the protocol. In one preferred embodiment, a sender of a Financial Information Exchange (FIX) message uses the order quantity field (“tag 38”) to communicate coded instructions to the message receiver on how to interpret the contents of the financial message.

The invention allows a party to define how values placed in the order quantity field will be interpreted. For example, the value may act as a code changing the meaning of the message from the FIX standard meaning to some other meaning. The exact meaning given to the coded number(s) may be different for each sender/receiver pair, or the same or similar codes may be used between a single sender and a plurality of receivers, as well as between any number of sender/receiver pairs.

The present invention is beneficial in that there are no additional costs associated with encoding messages, there is no additional software associated with encoding messages, and there is no significant learning curve for users utilizing the invention.

In one aspect, the invention encompasses a method for securely communicating financial information, the method comprising: receiving over an electronic computer network a coded message comprising an entry in a specified field of a field delimited communication protocol, and interpreting the encoded message to have a meaning different from a publicly-known meaning for entries in said specified field.

In one embodiment of the invention, the field delimited communication protocol is the Financial Information Exchange (FIX) Protocol, or a protocol derived therefrom.

In another embodiment, the specified field is an order value field.

In further embodiment, the specified field comprises a FIX tag 38 entry.

In one embodiment, the encoded message corresponds to a number of shares.

In another embodiment, the encoded message corresponds to an Indication of Interest (IOI) for a number of shares.

In another aspect, the present invention encompasses a method for securely communicating financial information, the method comprising: encoding a message comprising an entry in a specified field of a field delimited communication protocol, wherein said encoded message is intended to have a meaning different from a publicly-known meaning for entries in said specified field; and transmitting the encoded message over an electronic computer network.

### BRIEF DESCRIPTION OF THE DRAWINGS

FIG. 1 is a block diagram illustrating one embodiment of the present invention;

FIG. 2 is a flow diagram illustrating aspects of system operation in one embodiment for the invention;

FIG. 3 is a block diagram illustrating yet another preferred of the present invention; and

FIG. 4 is a flow diagram illustrating aspects of system operation of the embodiment described in FIG. 3.

### DETAILED DESCRIPTION OF PREFERRED EMBODIMENTS

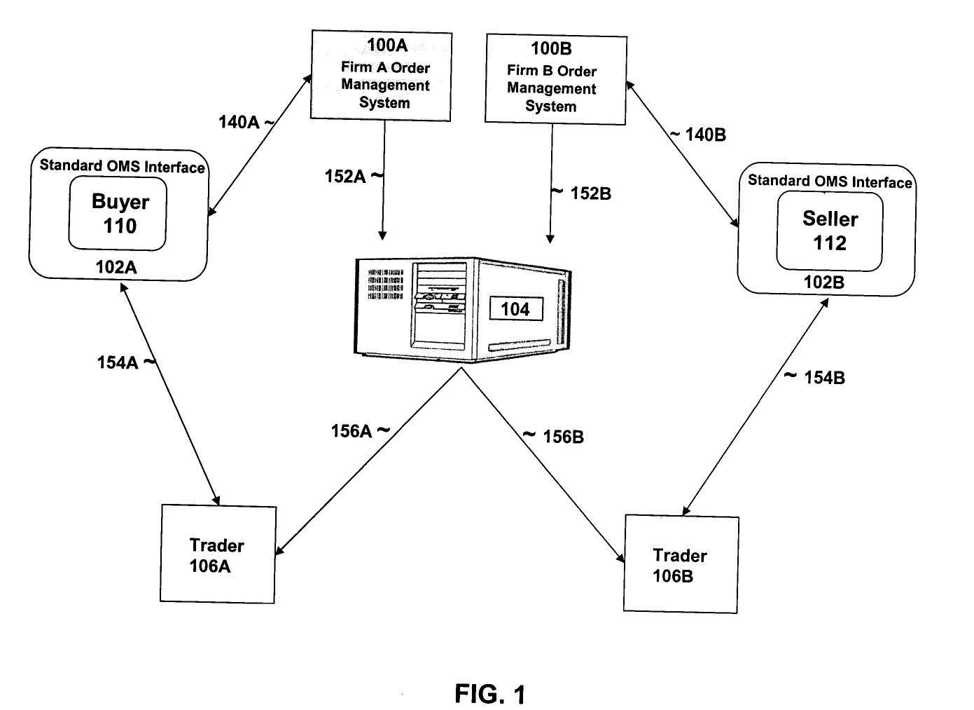

FIG. 1 illustrates one preferred embodiment of the present invention. Shown in FIG. 1 is a buyer 110 and a seller 112 utilizing the typical order management system interfaces 102A and 102B of firms 100A and 100B respectively. Order management system interface 102 is preferably a personal computer, remote terminal, workstation, or other computing entry device adapted for user interaction with a firm order management system 100. As shown in FIG. 1, order entry interface 102 connects to order management system 100 via connection 140. As known in the art, order management system interface 102 may connect to order management system 100 via a direct connection, a local intranet, internet connection, or other suitable electronic network connection.

Also shown in FIG. 1 is secure repository 104. Secure repository 104 is a computing device adapted to facilitate financial transactions between a buyer 110 and a seller 112. In one preferred embodiment, information transmitted to secure repository 104 is kept confidential. In this way transactions between buyer 110 and seller 112 remain anonymous. In other preferred embodiments, the identities of the parties may be made available to each other via secure repository 104.

Order management system 100 preferably communicates with secure repository 104 via connection 152. As shown in FIG. 1, each firm 100 preferably maintains a separate connection, connections 152A and 152B, with secure repository 104. As known in the art, connection 152 may be established via a secure internet or other suitable electronic network connection. Communication via connection 152 is preferably governed by a field delimited communication protocol. One such protocol utilized in the field of financial transactions is the Financial Information Exchange (FIX) protocol.

Also shown in FIG. 1 are traders 106. Traders 106 facilitate stock sales and purchases between buyers and sellers. As known in the art, traders 106 may be brokers/dealers. Traders 106 communicate with their respective buyer 110 and seller 112 via connections 154A and 154B, respectively. In one preferred embodiment, connection 154 is a telephonic connection. In another preferred embodiment, connection 154 is a data connection via an internet or other suitable network connection. As will be recognized, any combination of telephonic or electronic network connections are acceptable.

Traders 106 also communicate with secure repository 104 via network connections 156A and 156B. In a preferred embodiment, matched orders, as described in detail below, are communicated to traders 106A and 106B via connections 156A and 156B respectively.

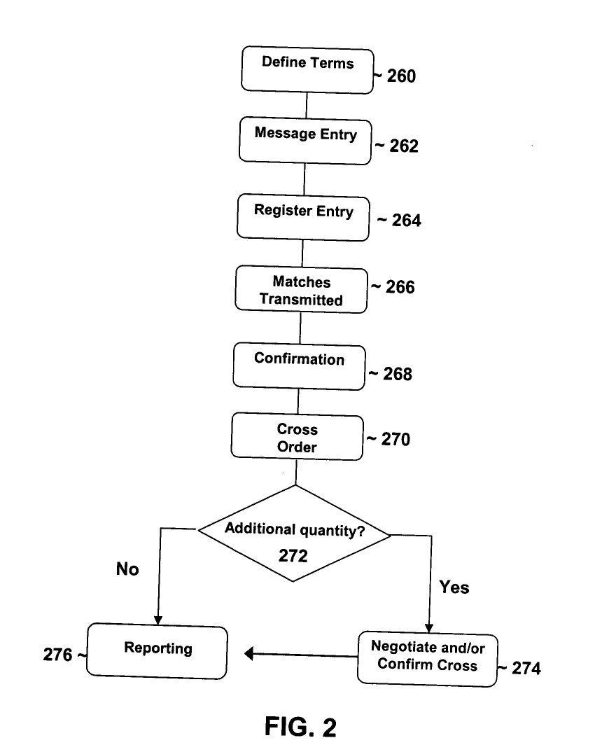

FIG. 2 is a flow diagram illustrating a preferred embodiment for securely communicating financial information over an electronic computer network. In this embodiment, the financial information communicated is information to initiate a stock trade between buyer 110 and seller 112. In another embodiment, the financial information transmitted is information regarding an Indication of Interest of a buyer in a particular stock.

As shown in FIG. 2, in step 260, buyer 110, seller 112, or a third party preferably defines how entries in specified fields of the field delimited communication protocol will be interpreted. In this way, entries in specified fields may represent coded messages outside of the publicly-known definitions those entries would ordinarily have. Specified fields are fields selected by a party that receive numeric, alphanumeric, or a combination of alphanumeric and numeric entries.

In one preferred embodiment, only one entity defines the encoding scheme for entries in one or more specified fields of the protocol, and distributes the encoding scheme to one or more parties that may be recipients of the encoded message. In another embodiment, one or more entities may agree as to the terms of the encoding scheme, and, if desired, distribute the encoding scheme to other parties.

As described above, the FIX protocol may be utilized for facilitating financial transactions between buyers and sellers. One specified field in the FIX protocol is tag number 38, which represents a number of shares ordered. Other fields may be specified, such as a FIX tag number 53 (“Quantity” field) or FIX tag number 135 (“Offer Size” field).

In one exemplary embodiment, a buyer B may define that when a seller A inputs only a single digit in the quantity field of a tag 38 entry, the single digit is a coded message signifying a purchase order of “single digit”×10,000. For example where a seller A inputs “38=5”, buyer B would not interpret the message as an order for 5 shares (FIX meaning), but as an order for 50,000 shares.

In another exemplary embodiment, a seller A may define a single digit in the quantity field of a tag 38 entry as a coded message signifying a purchase order of “single digit”×1,000. For example, where seller A inputs “38=5”, a buyer C would not interpret the message as an order for 5 shares (FIX meaning), but as an order for 5,000 shares.

In yet another exemplary embodiment, a buyer can communicate an indication of interest (IOI) in a stock to a receiver, not by sending an indication of interest message (FIX standard), but by sending an order message with a particular code number in the order quantity field of the order message. Specifically, a buyer A, a seller D, or other party, may agree that when A sends only a single digit in the quantity field of a tag 38 entry, the single digit is a coded message signifying an Indication of Interest (IOI) for “single digit”×10,000. For example, where A inputs “38=3”, D would not interpret the message as an order for 3 shares (FIX meaning), but as an indication of interest (IOI) for 30,000 shares. As illustrated in this example, the present invention enables a sender to send an “indication of interest for 30,000 shares” by sending an “order for 3 shares” message, rather than by sending an Indication of Interest message independently.

As will be recognized, the entries in the quantity field of a tag 38 entry, or other specified field, may be defined in any way. For example, having only one digit present in the quantity field could be defined to indicate an Indication of Interest for “single digit”×10,000, but having two digits present in the quantity field could be defined to indicate an order for “two digits”×1,000. In an alternate coding scheme, each number may correspond to a unique definition. For example, having “1” in the quantity field would indicate an order for 20,000 shares, having a “2” in the quantity field would indicate an order for 25,000 shares, having a “3” in the quantity field would indicate an order for 27,500 shares, etc.

Referring again to FIG. 2, in step 262 a buyer 110 and a seller 112 input financial information into order management system interfaces 102A and 102B respectively. In one preferred embodiment, buyer 110 inputs encoded financial information comprising the number of shares of stock the buyer is interested in purchasing, and seller 112 preferably inputs encoded financial information comprising the number of shares of stock the seller is interested in selling. In another embodiment, buyer 110 inputs financial information comprising an encoded indication of interest. As described above, such an indication of interest may also include a specific entry representing the number of shares the buyer is interested in. As further described above, such encoded entries may preferably be represented in the quantity field of a tag 38 entry.

In a preferred embodiment, at step 264, encoded messages transmitted from buyer 110 and seller 112 via their corresponding order management systems are received and registered at secure repository 104. The registration process may include parsing information contained within the message to extract entries from one or more specified fields. Registered messages are preferably stored electronically (e.g., in a database).

Secure repository 104 preferably utilizes information from registered entries to match similar requests by complementary parties. When a match between a buyer and a seller occurs, the results are transmitted, at step 266, to traders 106A and 106B associated with the matched parties. In a preferred embodiment, secure repository 104 utilizes a predefined matching scheme to associate two messages. As will be recognized, secure repository 104 may utilize various matching methods to accommodate the type of financial messages being transmitted by a buyer or a seller.

For example, where a buyer transmits a message containing a request to buy a certain number of shares of stock, secure repository 104 may match the buyer with a seller who transmits a message containing a request to sell the same number of shares of stock. As known in the art, this method matches the natural buyer with the natural seller, or the “natural other side.” In another embodiment, secure repository 104 matches messages where the offer to sell is equal to or greater than the offer to buy. In yet another embodiment, secure repository 104 matches messages as defined by the entity that operates the repository. In yet another embodiment, secure repository matches coded messages as defined by the encoding scheme described above. In yet another preferred embodiment, secure repository 104 is not privy to the encoding scheme, and therefore, matches encoded messages as if they were not encoded. The meaning of these matched messages is known only to the parties of the match.

After notification of a match, at step 268, traders 106A and 106B confirm the terms of the match with their respective buyer and/or seller. As described above, traders 106 may confirm via a telephonic connection and/or via a suitable electronic network connection. In one embodiment, traders 106 are aware of the encoding scheme prior to confirmation of the match. In another embodiment, traders 106 are made aware of the encoded message after a match has occurred.

In one embodiment, at step 270, traders 106A and 106B communicate with a broker (not shown) to complete the transaction under the terms of the matched entries (i.e., the confirmed orders are crossed). For example, trader 106A may transmit the confirmed terms of the matched entry to the broker, and trader 106B may transmit the confirmed terms of the matched entry to the same broker. In this way, the order can be crossed.

In step 272, brokers, under direction of their clients, may indicate that an additional quantity of stocks may be purchased or sold. In a preferred embodiment, these additional shares are purchased at the crossed price. In another preferred embodiment, at step 274, the terms of the additional shares are negotiated after the confirmed order is crossed.

In one embodiment, at step 276, when the transaction between the buyer and seller is complete, it is reported in the third market. In this way the parties to the transaction remain anonymous.

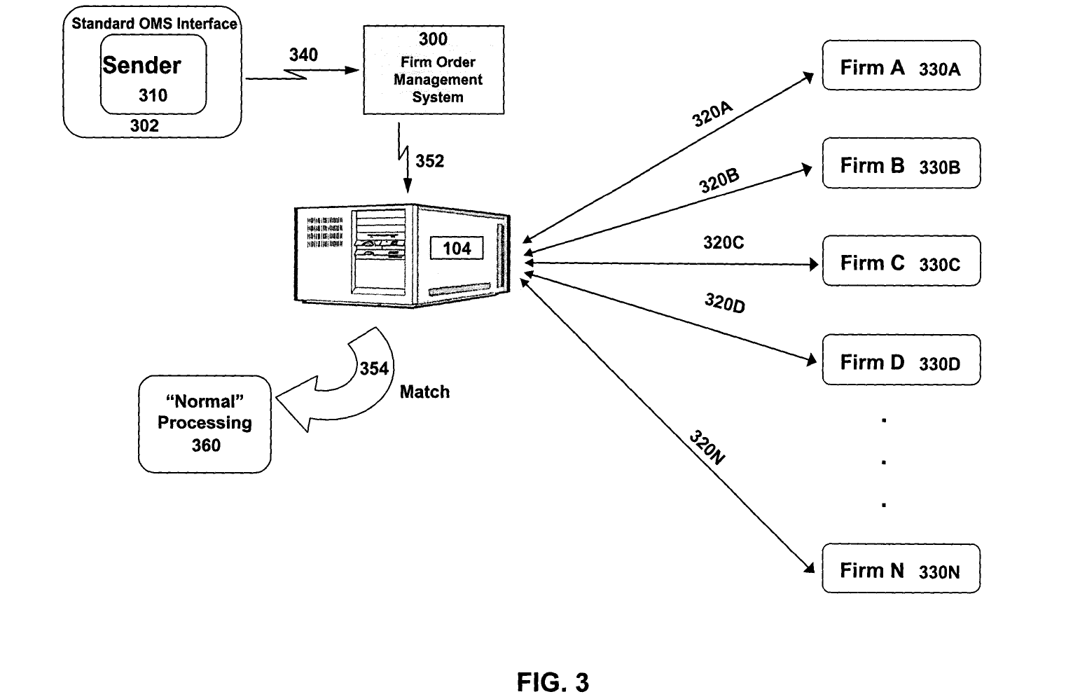

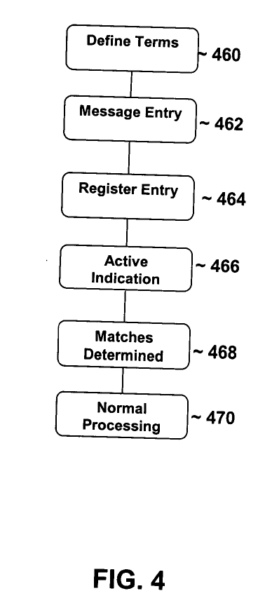

As will be recognized, the methodology of the embodiments described in connection with FIGS. 1-2 are sometimes referred to as “passive” indications in that secure repository 104 accepts financial messages from buyers and sellers and matches them based on some criteria. As will also be recognized, the embodiments described in connection with FIGS. 3-4 (below) are sometimes referred to as “active” indications in that the secure repository accepts a message from only one party (a sender), and actively transmits that message to solicit responses before a match occurs. Further, steps 266-276 are referred to as “normal” processing, in that these steps are completed in both active and passive indications.

FIG. 3 illustrates a preferred embodiment of the present invention known as an active indication. Shown in FIG. 3 is sender 310, who may be either a buyer or a seller. Sender 310 utilizes a typical order management system interface 302 of firm 300. Order management system interface 302 is preferably a personal computer, remote terminal, workstation, or other computing entry device adapted for user interaction with a firm order management system 300. As shown in FIG. 3, order entry interface 302 connects to order management system 300 via connection 340. As known in the art, connection 340 may be a direct connection, a local intranet connection, an internet connection, or other suitable electronic network connection.

Also shown in FIG. 3 is secure repository 104. Secure repository 104 is a computing device adapted to facilitate financial transactions between a sender 310 and a plurality of message receivers, firms 330A-330N. In one preferred embodiment, information transmitted to secure repository 104 is kept confidential. In this way transactions between sender 310 and receivers 330 remain anonymous. In other preferred embodiments, the identities of the parties may be made available to each other via secure repository 104. In yet another preferred embodiment, receivers 330A-330N are designated by sender 310. In this way, the sender remains anonymous to all parties, and the receivers remain anonymous to each other. In yet another preferred embodiment, the sender may define categories of receivers and members of those categories automatically receive message(s). This may also preserve the identity of the sender, as well as that of the some or all of the receivers of the message(s).

As shown in FIG. 3, firm 300 preferably maintains connection 352 with secure repository 104. Communication via connection 352 is preferably governed by a field delimited communication protocol. As described above, one such protocol utilized in the field of financial transactions is the Financial Information Exchange (FIX) protocol.

As shown in FIG. 3, firms 330A-330N communicate with secure repository 104 via connections 320A-320N respectively. As known in the art, connections 320 may be established via a secure telephonic, Internet or other suitable electronic network connection. Messages transmitted from secure repository 104 via connections 320 are preferably active indications in that no match is required before transmission of the message to the receiver. As described above, these receivers may be anonymous, may be designated by the sender, or may be members of a category designated by the sender. Further, these receivers may be clients of the entity that operates the secure repository. As will be recognized, where the sender is a buyer, the receivers are typically sellers, and vice versa.

As shown in FIG. 3, and described in detail below, when secure repository 104 determines that a match 354 has been made, “normal” processing occurs.

FIG. 4 is a flow diagram illustrating a preferred embodiment for securely communicating financial information over an electronic computer network in connection with FIG. 3. In this embodiment, the financial information communicated is information to initiate a stock trade between a sender 310 and firms 330. In another embodiment, the financial information transmitted is information regarding an Indication of Interest of sender 310 in a particular stock.

As shown in FIG. 4, in step 460, a sender 310, a firm (one of 330A-330N), or a third party preferably defines how entries in specified fields of the field delimited communication protocol will be interpreted. Defining these entries is described in detail in connection with FIG. 2. As described above, the FIX protocol may be utilized for facilitating financial transactions between senders and receivers.

In step 462 a sender inputs financial information into order management system interface 302. In one embodiment, sender 310 preferably inputs encoded financial information comprising the number of shares of stock they are interested in purchasing. In another embodiment, sender 310 inputs financial information comprising an encoded indication of interest for a particular stock. As described above, such an indication of interest may also include an encoded entry representing the number of shares the buyer is interested in. As further described above, such encoded entries are preferably represented in the quantity field of a tag 38 entry.

In a preferred embodiment, encoded messages are transmitted from sender 310 via order management system 300 to secure repository 104. The encoded message is then registered in step 464. As described above, registered messages may be stored electronically, e.g., in a database, and may include parsing information contained within the message to extract entries from specified fields.

After registration, in step 466, messages are actively transmitted to receivers 330. After receiving transmitted messages from secure repository 104, each firm 330 may reply to the active indication by submitting a response to secure repository 104. In step 468, secure repository 104 preferably utilizes information from registered entries and firm responses to active indications to match similar requests by complementary parties. When a match between a sender and a receiver occurs, in step 470, “normal” processing of the match proceeds as described above. When the transaction between the sender and receiver is complete, it is reported in the third market, as above, to maintain user anonymity.

In certain embodiments, rules may be in place that govern the transactions as described in connection with the present invention. For example, a rule may specify a minimum number of ordered shares, e.g. 10,000 shares. Another rule may specify that no short trades will be allowed. Other rules may specify that matched crosses are made at the midpoint, while other crosses are made at a negotiated price. The invention is preferably adapted to ensure that all parties adhere to those rules that are currently in place.

Although the preferred embodiments of the present invention have been disclosed for illustrative purposes, those skilled in the art will appreciate that various modifications, tat additions and substitutions are possible, without departing from the scope and spirit of the invention as recited in the accompanying claims.

What is claimed is:

1. A method for securely communicating financial information, comprising:
receiving over an electronic computer network a coded message comprising an entry in a specified field of a field delimited communication protocol; and
interpreting said coded message to have a meaning different from a publicly-known meaning for entries in said specified field.

2. The method of claim 1, wherein the field delimited communication protocol is the Financial Information Exchange (FIX) Protocol, or a protocol derived therefrom.

3. The method of claim 1, wherein the specified field is an order value field.

4. The method of claim 1, wherein the specified field comprises a FIX tag 38 entry.

5. The method of claim 1, wherein the encoded message corresponds to a number of shares.

6. The method of claim 1, wherein the encoded message corresponds to an Indication of Interest (IOI) for a number of shares.

7. A method for securely communicating financial information, comprising:
encoding a message comprising an entry in a specified field of a field delimited communication protocol, wherein said encoded message is intended to have a meaning different from a publicly-known meaning for entries in said specified field; and
transmitting said encoded message over an electronic computer network.

8. The method of claim 7, wherein the field delimited communication protocol is the Financial Information Exchange (FIX) Protocol, or a protocol derived therefrom.

9. The method of claim 7, wherein the specified field is an order value field.

10. The method of claim 7, wherein the specified field comprises a FIX tag 38 entry.

11. The method of claim 7, wherein the encoded message corresponds to a number of shares.

12. The method of claim 7, wherein the encoded message corresponds to an Indication of Interest (IOI) for a number of shares.

13. A method for securely communicating financial information, comprising:
receiving over a first electronic computer network a first message, said message comprising a first entry in a specified field of a field delimited communication protocol;
transmitting over a second electronic computer network, a second message, said second message comprising a second entry in said specified field of said field delimited communication protocol; and
at least one of said first and second messages being encoded, wherein each encoded message is intended to have a meaning different from a publicly-known meaning for entries in said specified field;
wherein, said first and second electronic network, said first and second entries, and said first and second messages are not necessarily distinct.

14. The method of claim 13, wherein the field delimited communication protocol is the Financial Information Exchange (FIX) Protocol, or a protocol derived therefrom.

15. The method of claim 13, wherein the specified field is an order value field.

16. The method of claim 13, wherein the encoded message corresponds to a number of shares.

17. The method of claim 13, wherein the encoded message corresponds to an Indication of Interest (IOI) for a number of shares.

18. The method of claim 13, wherein said first and second messages are both encoded, further comprising:
determining whether corresponding entries in said specified field of said messages match; and
if the match is successful, transmitting a notification to one or more broker/dealers.

19. The method of claim 18, wherein the transmitted notification is not encoded.

20. The method of claim 13, wherein said first message is encoded, and wherein said transmitting is to a plurality of receivers, further comprising:
receiving from a receiver a reply to said second message; and
determining whether corresponding entries in the specified field of the first message and said reply match.

21. The method of claim 20, wherein if the match is successful, transmitting a notification to one or more broker dealers.

22. An apparatus for securely communicating financial information, comprising:
a receiver for receiving over an electronic computer network a coded message comprising an entry in a specified field of a field delimited communication protocol; and
an interpreter for interpreting said coded message to have a meaning different from a publicly-known meaning for entries in said specified field.

23. An apparatus for securely communicating financial information, comprising:
an encoder for encoding a message comprising an entry in a specified field of a field delimited communication protocol, wherein said encoded message is intended to have a meaning different from a publicly-known meaning for entries in said specified field; and
a transmitter for transmitting said encoded message over an electronic computer network.

24. An apparatus for securely communicating financial information, comprising:
a receiver for receiving over a first electronic computer network a first message, said message comprising a first entry in a specified field of a field delimited communication protocol;
a transmitter for transmitting over a second electronic computer network, a second message, said second message comprising a second entry in said specified field of said field delimited communication protocol; and
at least one of said first and second messages being encoded, wherein each encoded message is intended to have a meaning different from a publicly-known meaning for entries in said specified field;
wherein, said first and second electronic network, said first and second entries, and said first and second messages are not necessarily distinct.
